(19) United States
(12) Patent Application Publication
(10) Pub. No.: US 2011/0072516 A1
(43) Pub. Date: Mar. 24, 2011

(54) PREVENTION OF DISTRIBUTED DENIAL OF SERVICE ATTACKS

(76) Inventors: MATTHEW L. COHEN, Irvine, CA (US); Daniel A. Kuykendall, La Mirada, CA (US)

(21) Appl. No.: 12/889,322

(22) Filed: Sep. 23, 2010

Related U.S. Application Data
(60) Provisional application No. 61/245,059, filed on Sep. 23, 2009.

(51) Int. Cl. G06F 21/00; G06F 15/16

(52) U.S. Cl. 726/22

(57) ABSTRACT

A method of automating the ability of a network to distinguish between a traffic generated by automated means and the traffic generated by human beings for blocking automated traffic during a distributed denial of service attack is disclosed. The method includes placing at least one validated traffic manager (VTM) computer on a computer network by a user. The method further includes monitoring a plurality of network requests by storing a plurality of user traffic source (UTS) lists such as a white list, a grey list and a black list on the at least one VTM computer. The method utilizes a reverse turning test (RTT) that includes a human verification process (HVP) to distinguish between the traffic generated by human beings and the automated traffic.

This application claims the benefit of U.S. Provisional Application No. 61/245,059 filed on Sep. 23, 2009.

### BACKGROUND OF THE INVENTION

1. Technical Field of the Invention

The present invention relates in general to prevention of distributed denial of service (DDoS) attacks. More specifically, the present invention relates to a method of automating the ability of a network to distinguish between the traffic generated by automated means and traffic generated by human beings for the purpose of blocking automated traffic during a denial of service (DoS) attack.

2. Description of the Related Art

The most effective way to harm a target website is to prevent it from serving its purpose; this is called a denial of service (DoS) attack. The attacker overwhelms a server with millions of concurrent requests so that the target network is overwhelmed and unable to respond to normal users. These attacks were initially created from a relatively large number of requests from a relatively small number of attacking computers. Network administrators initially responded by learning to block the Internet protocol (IP) addresses of the attackers, thus preventing their systems from being overwhelmed. Attackers responded by creating a distributed denial of service (DDoS) attack.

In this attack method, a very large number of computers are used to attack the target. Each computer makes a normal number of requests per minute, thus it is difficult or impossible to distinguish the attacking computer from a regular user. A zombie network (or botnet) of hundreds of thousands or millions of computers can create enough requests that it can overwhelm any network. Hackers can easily assemble these networks from so-called zombie computers. Zombie computers are computers belonging to normal users around the internet which have been infected by a virus (or other malware) which does no damage to the users programs or data, but simply allows the zombie master to use the computer to run processes. These zombie networks are so prevalent that hackers can rent or purchase them on the open market at an extremely low cost. They are often used for DDoS attacks, spam or other unwanted behavior.

U.S. Pat. No. 6,886,102 to Lyle on Apr. 26, 2005 teaches a system and method for determining whether a sender seeking to send a message to a receiving computer system via a network is an authorized sender. A request to communicate is received from the sender. A number N1 is selected. A hash value for the number N1 is calculated. The hash value is sent to the sender. However, this method is not designed to identify the difference between the traffic generated by automated means and traffic generated by human beings.

U.S. Pat. No. 7,089,303 to Sheymov on Aug. 8, 2006 discloses a system and method for distributed network protection. By distributing various information and monitoring centers that monitor distributed networks and unauthorized access attempts, it is possible to, for example, more quickly defend against an unauthorized access attempts. For example, a Level 1 monitoring center could monitor a predetermined geographical area serving, for example, a wide variety of commercial and public sites, an organizational structure, or the like, for alarms. Upon analyzing an alarm for various characteristics, the Level 1 monitoring center can refer the unauthorized access attempt to an appropriate Level 2 center for, for example, possible retaliatory and/or legal action. Then, a Level 3 monitoring center can record and maintain an overall picture of the security of one or more networks, the plurality of monitoring centers and information about one or more hacking attempts. However, this method proved to be expensive and require extensive level of automation for implementation.

Hence, it can be seen, that there is a need for automating computer networks to distinguish between traffic generated by automated means and traffic generated by human beings to defend web applications against (DDoS) attacks. Further, the needed method would provide a streamlined and relatively inexpensive solution against (DDoS) attacks; and would require a minimum level of automation for implementation.

Thus, there is a need for automating computer networks to distinguish between traffic generated by automated means and traffic generated by human beings to defend web applications against (DDoS) attacks. Further, the needed method would provide a streamlined and relatively inexpensive solution against (DDoS) attacks and would require a minimum level of automation for implementation.

### SUMMARY OF THE INVENTION

To minimize the limitations found in the prior art, and to minimize other limitations that will be apparent upon the reading of the specifications, the present invention discloses a method of automating the ability of a network to distinguish between traffic generated by automated means and traffic generated by human beings for blocking automated traffic during a denial of service attack. The method includes placing at least one validated traffic manager (VTM) computer on a computer network by a user. A plurality of network requests may be monitored by way of the at least one VTM computer. A plurality of user traffic source (UTS) lists such as a white list, a grey list and a black list may be stored on the at least one VTM computer. The network activities may be monitored by utilizing a plurality of conditions defined in an engagement threshold. The data from a validated human tracking system (VhaTS) may be processed by comparing with the plurality of UTS lists. The VhaTS may be engaged when the conditions defined engagement threshold is met. A plurality of network hosts may be tested by utilizing the white list, grey list and black list before sending data. The data may be forwarded to a web server if the UTS is in the white list or grey list. The data may be locked if the UTS is in the black list. The data may be sent to a human verification process (HVP) if the UTS is not in the list. The user is determined as a human being or an automated means utilizing a reverse turing test (RTT) provided by the HVP. A message may be provided by the at least one VTM computer if the user fails in the RTT. The user access request may be allowed to a website by the at least one VTM if the user passes in the RTT.

One objective of the invention is to provide a method for automating computer networks to distinguish between traffic generated by automated means and traffic generated by human beings to defend web applications against (DDoS) attacks.

Another objective of the invention is to provide a streamlined and relatively inexpensive solution against (DDoS) attacks.

A third objective of the invention is to provide a method that requires a minimum level of automation for implementation.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic diagram of the present invention illustrating a method of automating the ability of a network to distinguish between traffic generated by automated means and traffic generated by human beings for blocking automated traffic during a denial of service attack.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

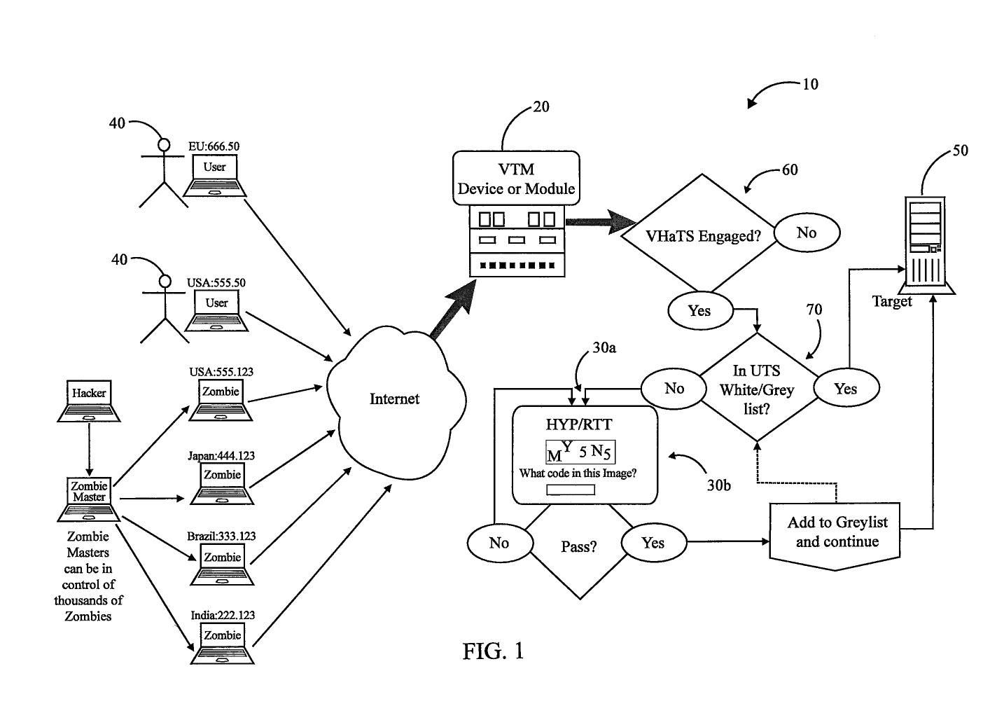

FIG. 1 is a schematic diagram 10 of the present invention illustrating a method of automating the ability of a network to distinguish between traffic generated by automated means and traffic generated by human beings for blocking automated traffic during a denial of service attack. The method includes placing at least one validated traffic manager (VTM) computer 20 on a computer network by a user 40. A plurality of network requests may be monitored by way of the at least one VTM computer 20. A plurality of user traffic source (UTS) 70 lists such as a white list, a grey list and a black list may be stored on the at least one VTM computer 20. The network activities may be monitored by utilizing a plurality of conditions defined in an engagement threshold. The data from a validated human tracking system (VhaTS) 60 may be processed by comparing with the plurality of UTS lists 70. The VhaTS 60 may be engaged when the conditions defined engagement threshold is met. A plurality of network hosts may be tested by utilizing the white list, grey list and black list before sending the data and forwarding the data to a web server if the UTS 70 is in the white list or grey list. The data may be blocked if the UTS 70 is in the black list. The data may be sent to a human verification process (HVP) 30a if the UTS 70 is not in the list. The user 40 is determined as a human being or an automated means by conducting a reverse turing test (RTT) 30b provided by the HVP 30a. A message may be provided by the at least one VTM computer 20 if the user 40 fails in the RTT 30b. Finally the user access request may be allowed to a website by the at least one VTM 20 if the user 40 passes in the RTT 30b.

The RTT 30b may be a completely automated public during test to tell computers and humans apart (CAPTCHA) test. The UTS 70 is used to identify incoming network traffic against stored lists. The UTS 70 may be based on a hardware media access control (MAC) address, internet protocol (IP) address, a web browser cookie and the like. The VTM 20 may be set up on a computer as a stand-alone solution, as a module/plug-in to an existing load balancer, as a plug-in/extension/module to a web server software. The plug-in/extension/module to a web server software may be implemented on a reverse proxy, forwarding proxy or as a software library to the application code. The plurality of UTS lists 70 may include at least one storage mechanism such as a database stored in a random access memory (RAM), a hard disk drive (HDD) based solutions and the like. The storage mechanism may be paired with a single or a group of VTM 20 computers. The VTM 20 may initiate its operation when the traffic exceeds the engagement threshold and VTM may be disengaged when the traffic is below the engagement threshold. The white list may be a list of per-approved UTS 70. The grey list may be a dynamically generated list of UTS 70 based on the VhaTS 60. The black list may be a list of non-approved UTS 70. The VTM 20 computers may be configured with logging and the ability to search and create reports from the at least one storage mechanism. The HVP 30a may be expanded to use a plurality of reverse turing tests. The HVP 30a may be expanded to use alternate browser based solutions such as JavaScript/flash execution routines to identify the use of a real web browser to make the solution fully transparent to the end user 40.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method of automating the ability of a network to distinguish between a traffic generated by automated means and traffic generated by human beings for blocking automated traffic during a distributed denial of service attack, the method comprising the steps of:
(a) placing at least one validated traffic manager (VTM) computer on a computer network by a user;
(b) monitoring a plurality of network requests by way of the at least one VTM computer;
(c) storing a plurality of user traffic source (UTS) lists such as a white list, a grey list and a black list on the at least one VTM computer;
(d) monitoring network activities utilizing a plurality of conditions defined in an engagement threshold;
(e) processing data from a validated human tracking system (VhaTS) comparing with the plurality of UTS lists;
(f) engaging the VhaTS when the conditions defined engagement threshold is met;
(g) testing a plurality of network hosts utilizing the white list, grey list and black list before sending data;
(h) forwarding the data to a web server if the UTS is in the white list or grey list;
(i) blocking the data if the UTS is in the black list;
(j) sending the data to a human verification process (HVP) if the UTS is not in the list;
(k) determining if the user is a human being or an automated means by utilizing a reverse turing test (RTT) provided by the HVP;
(l) providing a message by the at least one VTM computer if the user fails in the RTT; and
(m) allowing the user access request to a website by the at least one VTM computer if the user passes the RTT.

2. The method of claim 1 wherein the RTT may be a completely automated public turing test to tell computers and humans apart (CAPTCHA) test.

3. The method of claim 1 wherein the UTS may be used to identify incoming network traffic against stored lists.

4. The method of claim 1 wherein the UTS may be based on a hardware media access control (MAC) address, Internet protocol (IP) address, a web browser cookie and the like.

5. The method of claim 1 wherein the VTM may be set up on a computer as a stand-alone solution, as a module/plug-in to an existing load balancer, as a plug-in/extension/module to a web server software.

6. The method of claim 5 wherein the plug-in/extension/module to the web server software may be implemented on a reverse proxy, forwarding proxy or as a software library to the application code.

7. The method of claim 1 wherein the plurality of UTS lists may include at least one storage mechanism such as a database stored in a random access memory (RAM), a hard disk drive (HDD) based solutions and the like.

8. The method of claim 7 wherein the storage mechanism may be paired with a single or a group of VTM computers.

9. The method of claim 1 wherein the white list may be a list of per-approved user traffic sources.

10. The method of claim 1 wherein the grey list may be a dynamically generated list of user traffic sources based on the VhaTS.

11. The method of claim 1 wherein the VTM may initiate the operation when the traffic exceeds the engagement threshold.

12. The method of claim 1 wherein the VTM may be disengaged when the traffic is below the engagement threshold.

13. The method of claim 1 wherein the black list may be a list of non-approved UTS.

14. The method of claim 1 wherein the VTM computers may be configured with logging and the ability to search and create reports from the at least one storage mechanism.

15. The method of claim 1 wherein the HVP may be expanded to use a plurality of reverse turing tests.

16. The method of claim 1 wherein the HVP may be expanded to use alternate browser based solutions such as JavaScript/flash execution routines to identify the use of a real web browser to make the solution fully transparent to an end user.
